(19) United States
(12) Patent Application Publication
(10) Pub. No.: US 2011/0320452 A1
(43) Pub. Date: Dec. 29, 2011

(54) INFORMATION ESTIMATION APPARATUS, INFORMATION ESTIMATION METHOD, AND COMPUTER-READABLE RECORDING MEDIUM

(75) Inventors: Takao Kawai, Tokyo (JP); Satoshi Nakazawa, Tokyo (JP); Shinichi Ando, Tokyo (JP)

(73) Assignee: Nec Corpration, Tokyo (JP)

(21) Appl. No.: 13/141,365

(22) PCT Filed: Dec. 21, 2009
(86) PCT No.: PCT/JP2009/007072

§ 371 Date: Jul. 12, 2011

(30) Foreign Application Priority Data
Dec. 26, 2008 (JP) 2008-335328

(51) Int. Cl. G06F 17/30

(52) U.S. Cl. 707/737; 707/E17.089

(57) ABSTRACT

An information estimation apparatus 1 for estimating a transmission point in time of a document whose transmission point in time is not specified in a document set to be analyzed includes a structure analysis unit 3 configured to specify, from the document set, a document having a document structure in which a link relationship with another document is indicated in a table-of-contents manner, and extract the link relationship of documents included in the document set from the document structure of the specified document, a grouping unit 4 configured to set a group of documents using the specified document and the extracted link relationship, and an estimation unit 5 configured to estimate, based on the set group and a transmission point in time of a document that is included in the group and whose transmission point in time is specified, a transmission point in time of a document that is included in the group and whose transmission point in time is not specified.

### TECHNICAL FIELD

The present invention relates to an information estimation apparatus, an information estimation method, and a computer-readable recording medium.

### BACKGROUND ART

Following a decrease in the cost for information transmission, an enormous amount of information is provided on the Internet today. Similarly, a large amount of information is also provided on the intranet of companies and the like. In many cases, such information is provided as web pages using the mechanisms of the “World Wide Web” (“web”). A user can find necessary information from such web pages.

Since web pages provide all sorts of information, it is necessary to determine whether the information is accurate. As one key to such a determination, information such as the date and time when content of a web page or the like is transmitted is useful and helpful.

However, information such as the transmission date and transmission time is not necessarily given to all web pages and content. Accordingly, it is difficult to determine when a page to which information such as the transmission date or transmission time is not given was transmitted. In view of this, for example, Patent Document 1 proposes one method for presenting to a user when content was uploaded, even if the creation date of this content is not explicitly written in the web page (Patent Document 1).

In the method of Patent Document 1, first, the user designates a web page in which information on updated pages is collected in a list. Information on links to the updated pages is obtained from this web page that has been designated (designated web page). Moreover, the designated web page is periodically referenced so as to compare a previous designated web page with a current designated web page, and if a new difference is found in information on links to updated pages as a result of the comparison, the date when the designated web pages were compared is assumed to be a creation date of the linked pages.

Non-Patent Document 1 discloses a method for estimating a transmission date of a web page whose transmission date is unknown using a web page whose transmission date is already known. Specifically, first, document clustering is performed on web pages relating to a similar period and content based on words in the pages, and subsequently, it is determined which cluster a web page whose transmission date is unknown should be sorted into. Then, the transmission date of the web page whose transmission date is unknown is estimated using the transmission date of the plurality of web pages in the cluster into which the web page was sorted.

### PRIOR ART DOCUMENTS

### Patent Document

Patent Document 1: JP 2007-141033A

### Non-Patent Document

Non-Patent Document 1: Hiroshi UEJIMA, Takao MIURA, Isamu SHIOYA: “Estimating Timestamp From Incomplete News Corpus”, COMMUNICATIONS IN INFORMATION AND SYSTEMS, Vol. 4, No. 4, pp. 273-288 (2004)

### SUMMARY OF THE INVENTION

### Problems to be Solved by the Invention

However, the methods disclosed in Patent Document 1 and Non-Patent Document 1 described above have the following problems. First, the method disclosed in Patent Document 1 has a problem that since it is necessary to designate a web page in which updated pages are collected in a list, a web page that is not described in such a web page cannot be handled.

On the other hand, in the method disclosed in Non-Patent Document 1, the transmission date of a web page whose transmission date is unknown is estimated using a web page whose transmission date is known. Accordingly, it is not necessary to designate a web page in which updated pages are collected in a list.

However, the method disclosed in Non-Patent Document 1 has a problem that since a transmission date is estimated based on words in web pages, estimation cannot be correctly performed if each web page has a different word appearance tendency. Specifically, if words used in each web page are different, a web page cannot be appropriately sorted into a cluster into which the page should originally be sorted, and thus estimation cannot be correctly performed.

An object of the present invention is to solve the above problems and to provide an information estimation apparatus, an information estimation method, and a computer-readable recording medium that are capable of estimating a transmission point in time of content, even in a case where a transmission date or a time expression is not explicitly described in a document that constitutes the content.

### Means for Solving the Problems

In order to achieve the above object, an information estimation apparatus of the present invention is an information estimation apparatus for estimating a transmission point in time of a document whose transmission point in time is not specified in a document set to be analyzed, including:

a structure analysis unit configured to specify, from the document set, a document having a document structure in which a link relationship with another document is indicated in a table-of-contents manner, and extract the link relationship of documents included in the document set from the document structure of the specified document;

a grouping unit configured to set a group of documents using the document specified by the structure analysis unit and the link relationship extracted by the structure analysis unit; and

an estimation unit configured to estimate, based on the group set by the grouping unit and a transmission point in time of a document that is included in the group and whose transmission point in time is specified, a transmission point in time of a document that is included in the group and whose transmission point in time is not specified.

Further, in order to achieve the above object, an information estimation method of the present invention is an information estimation method for estimating a transmission point in time of a document whose transmission point in time is not specified in a document set to be analyzed, including the steps of:

(a) specifying, from the document set, a document having a document structure in which a link relationship with another document is indicated in a table-of-contents manner, and extracting the link relationship of documents included in the document set from the document structure of the specified document;

(b) setting a group of documents using the document specified in the step (a) and the link relationship extracted in the step (a); and

(c) estimating, based on the group set in the step (b) and a transmission point in time of a document that is included in the group and whose transmission point in time is specified, a transmission point in time of a document that is included in the group and whose transmission point in time is not specified.

Moreover, in order to achieve the above object, a computer-readable recording medium of the present invention is a computer-readable recording medium having recorded thereon a program for causing a computer to estimate a transmission point in time of a document whose transmission point in time is not specified in a document set to be analyzed, the program including a command for causing the computer to execute the steps of:

(a) specifying, from the document set, a document having a document structure in which a link relationship with another document is indicated in a table-of-contents manner, and extracting the link relationship of documents included in the document set from the document structure of the specified document;

(b) setting a group of documents using the document specified in the step (a) and the link relationship extracted in the step (a); and

(c) estimating, based on the group set in the step (b) and a transmission point in time of a document that is included in the group and whose transmission point in time is specified, a transmission point in time of a document that is included in the group and whose transmission point in time is not specified.

### Effects of the Invention

As described above, according to the information estimation apparatus, the information estimation method, and the computer-readable recording medium of the present invention, it is possible to estimate a transmission point in time of content, even in a case where a transmission date or a time expression is not explicitly described in a document that constitutes the content.

### BRIEF DESCRIPTION OF DRAWINGS

FIG. 1 is a block diagram showing a schematic configuration of an information estimation apparatus according to an embodiment of the present invention.

FIG. 2 is a diagram showing a link relationship in a document set to be analyzed.

FIG. 3 is a flowchart showing the flow of processing in an information estimation method according to the embodiment of the present invention.

FIG. 4 is a diagram showing results of determination as to whether a transmission point in time of each document indicated by a document ID is specified.

FIG. 5 is a diagram showing referers and links in the link relationship shown in FIG. 2.

FIG. 6 is a diagram showing an example of a document structure in which a link relationship of an arbitrary document with another document is indicated in a table-of-contents manner.

FIG. 7 is a diagram showing an example of a document structure in which a link relationship of an arbitrary document with another document is indicated in a table-of-contents manner.

FIG. 8 is a diagram showing an example of group setting.

FIG. 9 is a diagram showing results of estimation processing.

### DESCRIPTION OF THE INVENTION

### Embodiment

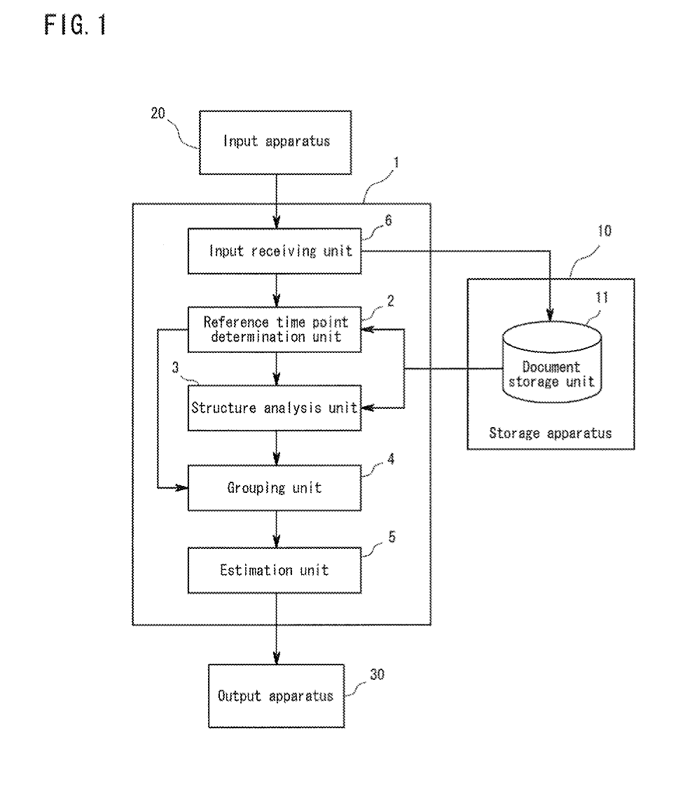

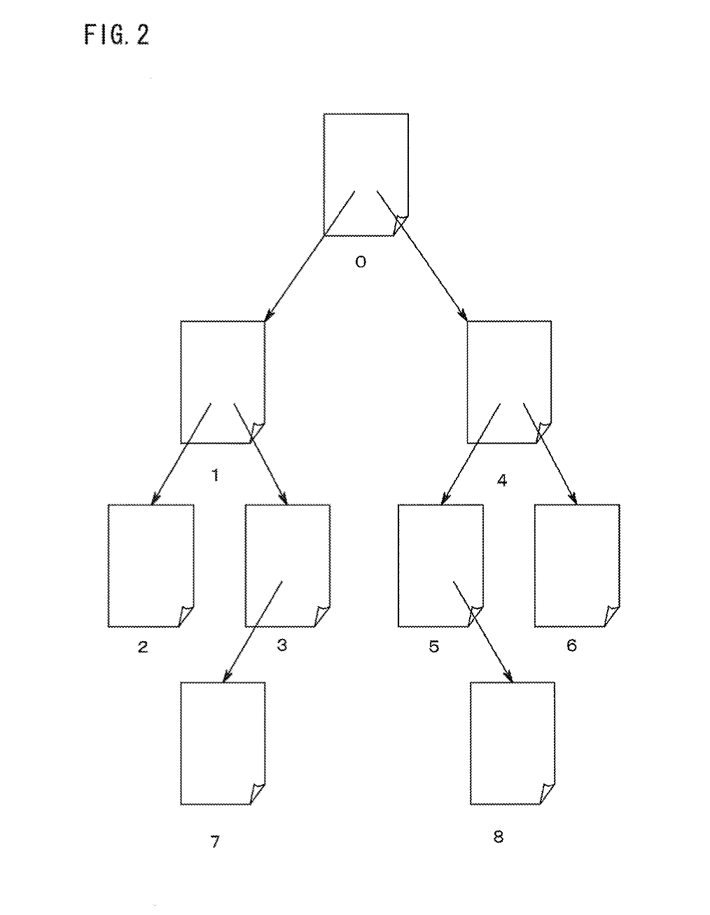

Below is a description of an information estimation apparatus, an information estimation method, and a program according to an embodiment of the invention, with reference to FIGS. 1 to 3. First is a description of a configuration of the information estimation apparatus according to the present embodiment. FIG. 1 is a block diagram showing a schematic configuration of the information estimation apparatus according to the embodiment of the invention. FIG. 2 is a diagram showing a link relationship in a document set to be analyzed.

An information estimation apparatus 1 shown in FIG. 1 is an apparatus that estimates a transmission point in time of a document whose transmission point in time is not specified in a document set to be analyzed. As shown in FIG. 1, the information estimation apparatus 1 is provided with a structure analysis unit 3, a grouping unit 4, and an estimation unit 5. Note that transmission points in time of some documents in the document set to be analyzed are specified.

The structure analysis unit 3 specifies a document that has a document structure in which a link relationship with another document is indicated in a table-of-contents manner from the document set to be analyzed, and further extracts a link relationship (see FIG. 2) of documents included in the document set from the document structure of the specified document.

Here, a “document structure” represents information that describes a logical document composition in a certain document. An example of a logical document composition is a document composition including constituent elements such as a summary portion, a title, a chapter, and a paragraph. In a case of a document having such constituent elements present in another document, if the document structure is analyzed, it is possible to specify a document that has a document structure in which a link relationship with another document is indicated in a table-of-contents manner.

Since a link relationship with another document is indicated in a table-of-contents manner in the document structure of the specified document, the structure analysis unit 3 can extract, from this document structure, a link relationship that is a candidate for a group having the same transmission point in time. The following is a reason for extracting a link relationship that indicates a candidate for a group having the same transmission point in time based on the document structure in which a link relationship with another document is indicated in a table-of-contents manner. Specifically, if logical constituent elements of a document are in a plurality of documents so as to form one composition, there is a high possibility that such a plurality of documents were transmitted during the same period. Thus, by specifying the link relationship with these documents, a document set transmitted during the same period can be specified, and the transmission point in time of each document can be estimated. For example, in the case of web pages, there is a case in which logical constituent elements of a document are in a plurality of web pages, and there is a high possibility that such web pages were transmitted at the same point in time. Thus, based on the transmission point in time of some of the web pages, it is possible to estimate a transmission point in time of another web page.

An example of a link relationship that is extracted is the link relationship shown in FIG. 2. FIG. 2 shows a graph structure in which documents are nodes, and links are edges. The direction of the arrow indicating each link means that a hyperlink is provided from a referer to a link.

The grouping unit 4 sets a group that includes a document whose transmission point in time is not specified, using a document specified by the structure analysis unit 3 and the link relationship likewise extracted by the structure analysis unit 3. Note that it is sufficient for the number of groups set by the grouping unit 4 to be one or more. Based on the group set by the grouping unit 4 and the transmission point in time of a document that is included in that group and whose transmission point in time is specified, the estimation unit 5 estimates a transmission point in time of the document that is included in that group and whose transmission point in time is not specified.

With such a configuration, even if either a transmission date or a time expression is not explicitly described in a document that constitutes content, the information estimation apparatus 1 can estimate about when the content was transmitted. The reason for this is because according to the information estimation apparatus 1, it is possible to estimate a set (group) of documents considered to have been transmitted during the same period based on a link relationship, using a document whose transmission point in time is specified.

Next is a more specific description of the information estimation apparatus 1 according to the present embodiment. As shown in FIG. 1, the information estimation apparatus 1 according to the present embodiment is realized by a computer that operates under the control of a program, as will be described later. The information estimation apparatus 1 is further provided with a reference time point determination unit 2 and an input receiving unit 6. The input receiving unit 6 receives information input from an external input apparatus.

The reference time point determination unit 2 determines with respect to each document included in the document set to be analyzed whether the transmission point in time is specified. For example, in FIG. 2, if the transmission points in time of a document whose document ID is 0, a document whose document ID is 1, and a document whose document ID is 4 are specified, the reference time point determination unit 2 determines that the transmission points in time of the three documents are specified. Note that in the following description, the document ID will be given in parentheses. For example, the document IDs will be given as Document (0), Document (1), and so on.

A storage apparatus 10, an input apparatus 20, and an output apparatus 30 are connected to the information estimation apparatus 1. The input apparatus 20 is an apparatus that inputs a document set to be analyzed and instructions to the information estimation apparatus 1. Examples of the input apparatus 20 include an input device such as a keyboard or a mouse and, furthermore, another computer connected via a network. The output apparatus 30 is an apparatus for notifying the outside of estimation results obtained by the estimation unit 5. An example of the output apparatus is an output device such as a display apparatus or a printing apparatus.

Here, the terms used in this specification will be described. A “transmission point in time” used in this specification represents time information with regard to a point in time at which certain content was transmitted. Time information is information on a date such as month and day or year, month, and day, for example. Further, a transmission point in time may be time information at the point in time when content was updated such as an update date, or may be time information at a point in time when content was created such as a creation date. In the information estimation apparatus 1 that estimates a transmission point in time, if it is necessary to distinguish up to a year, a transmission point in time needs to have all the year, month, and date elements. However, it is sufficient for a transmission point in time to have only day and month elements in the case where only the content created in a certain year is handled in the information estimation apparatus 1. Other than this, a transmission point in time may even have elements such as hour, minute, and second elements, in addition to year, month, and date elements.

A “document” used in this specification includes various information that can be read and stored by a data processing apparatus such as a computer. Examples of a document include a web page, a file, and a combination of files.

“Content” used in this specification represents the content of a document, and means an information unit having a certain unity. In other words, there is a case in which a document is made of one content, or there is also a case in which a document is made of a plurality of contents. For example, there is a case where a web page indicated by one certain URL includes a plurality of articles, and each article has a different transmission date. In this case, a web page is assumed to be a document, and each of the articles included in the page can be interpreted as one of the contents.

In Embodiment of the present invention, a document set that the input receiving unit 6 has accepted, that is, a document set to be analyzed is stored in a document storage unit 11 in the storage apparatus 10. A document set to be analyzed may be collected in advance, and stored in the document storage unit 11. Further, a configuration is also possible in which the information estimation apparatus 1 starts processing some of document sets, determines links thereof, and thereafter, collects more document sets as necessary, and stores the newly collected document sets in the document storage unit 11.

If a document set to be analyzed is a set of web pages, such a set may be restricted to, for example, a set of web pages whose URL belongs to a specific domain name, a set of web pages whose URL includes a directory path having a specific directory path, or the like. The reason for this is that a web page set made of content created at the same transmission point in time is often a web page set whose URL has the same domain name or a common directory path. Thus, it is possible to achieve, by providing such a restriction, an improvement in estimation precision and shortening of the processing time due to a decrease in the number of sets to be analyzed. Note that an aspect is possible in which processing is performed without providing such a restriction.

Moreover, in the present embodiment, if the documents are web pages as described above, the structure analysis unit 3 can specify a document that has a document structure described above, using at least one of an HTML tag and a subtree of a DOM tree, and a hyperlink that are described in the web page. Other than this, for example, in the case of an SGML file, the structure analysis unit 3 extracts a link relationship using at least one of an SGML tag and the tag structure, and a url tag. Further, in the case of an XML file, the structure analysis unit 3 extracts a link relationship using at least one of an XML tag and a subtree of an XML DOM tree, and link information such as Xlink.

In the present embodiment, the grouping unit 4 can set a group by combining a document whose transmission point in time is specified with a document that has a link to the above document and whose transmission point in time is not specified. Further, in this aspect, if a document whose transmission point in time is not specified has a link to a plurality of documents whose transmission point in time is specified, the grouping unit 4 sets a group by combining the document whose transmission point in time is not specified with a document whose transmission point in time is earlier. This enables estimation of a more accurate transmission point in time. This is because, generally, there are various types of logical relationships of documents, and thus a plurality of groups can be set, and although a certain document may redundantly belong to a plurality of groups, there is a high possibility that a logical relationship set later cites a document in a document set in a logical relationship previously set.

For example, as described above, consider the case where the transmission points in time of Documents (0), (1), and (4) are specified in FIG. 2. In this case, the grouping unit 4 can set one group using Document (0), set one group using Documents (1), (2), and (3), and set one group using Documents (4), (5), and (6).

In the present embodiment, if the above grouping is performed, the estimation unit 5 can estimate that a transmission point in time of a document whose transmission point in time is not specified in each group is the transmission point in time of a document whose transmission point in time is specified in that group. In the example in FIG. 2 described above, the estimation unit 5 estimates that the document transmission point in time of Documents (2) and (3) is the document transmission point in time of Document (1). Similarly, the estimation unit 5 estimates that the document transmission point in time of Documents (5) and (6) is the document transmission point in time of Document (1).

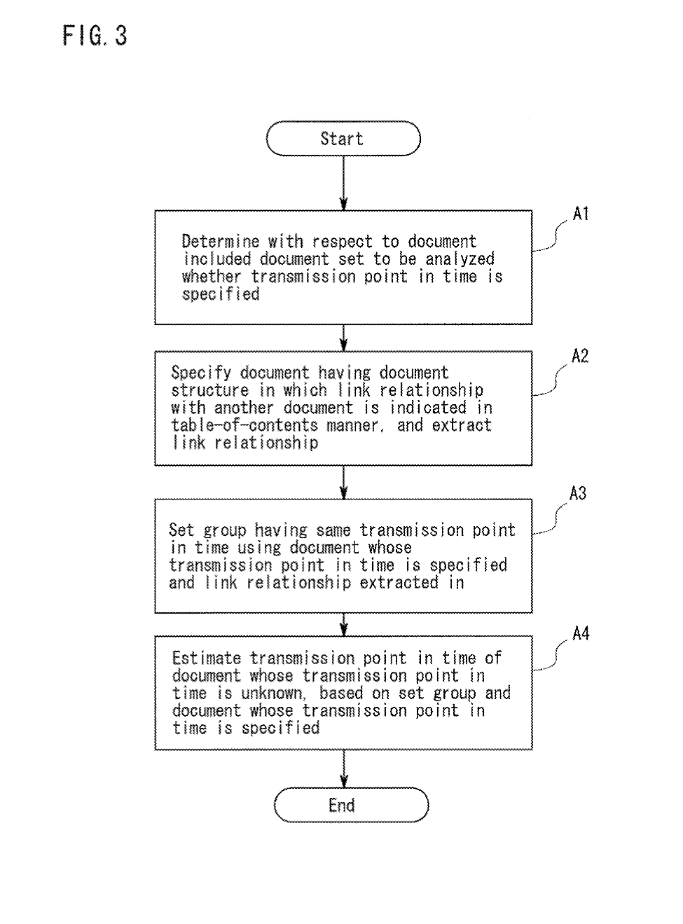

Next is a description of an information estimation method according to the embodiment of the present invention using FIG. 3. FIG. 3 is a flowchart showing the flow of processing in the information estimation method according to the embodiment of the present invention. Further, in the present embodiment, the information estimation method is implemented by causing the information estimation apparatus 1 shown in FIG. 1 to operate. Accordingly, in the following, the flow of processing in the information estimation method will be descried together with the operation of the information estimation apparatus 1 shown in FIG. 1 with reference to FIGS. 1 and 2 as appropriate.

As shown in FIG. 3, first, the reference time point determination unit 2 extracts a document set to be analyzed from the document storage unit 11, and determines with respect to each document included therein whether the transmission point in time is specified (step A1). The reference time point determination unit 2 inputs, to the structure analysis unit 3 and the grouping unit 4, information that indicates which document is the document whose transmission point in time is specified.

Next, the structure analysis unit 3 specifies, from the document set, a document having a document structure in which a link relationship with another document is indicated in a table-of-contents manner, and further extracts the link relationship (see FIG. 2) of documents included in the document set from the document structure of the specified document (step A2).

Next, the grouping unit 4 sets a document group including a document whose transmission point in time is not specified using the document specified in step A2 and the link relationship likewise extracted in step A2 (step A3). Specifically, the grouping unit 4 combines a document whose transmission point in time is specified with a document that has a link to that document and whose transmission point in time is not specified.

After that, based on the group set in step A3 and the transmission point in time of the document that is included in that group and whose transmission point in time is specified, the estimation unit 5 estimates a transmission point in time of the document that is included in that group and whose transmission point in time is not specified (step A4). Specifically, the estimation unit 5 uses the transmission point in time of the document whose transmission point in time is specified as a transmission point in time of a document whose transmission point in time is not specified in each group.

After that, the document whose transmission point in time has been estimated is output to the output apparatus 30, and a user is notified thereof. Thus, according to the information estimation method in the present embodiment, even if a transmission date or a time expression is not explicitly described in a document that constitutes content, it is possible to estimate about when that content was transmitted.

It is sufficient for a program according to the embodiment of the present invention to be a program that includes a command for causing a computer to execute steps A1 to A4 shown in FIG. 3. If the program according to the present embodiment is installed in a computer and executed, the information estimation apparatus according to the present embodiment can be realized, and the information processing method according to the present embodiment can be implemented. In this case, the CPU (central processing unit) of the computer functions as the reference time point determination unit 2, the structure analysis unit 3, the grouping unit 4, and the estimation unit 5, and performs processing. Further, in the present embodiment, the storage apparatus 10 can be realized by storing data files that constitute the storage apparatus 10 in a storage apparatus such as a hard disk provided in the computer.

Further, the program according to the embodiment of the present invention is supplied in the state where that program is stored in a computer-readable recording medium such as, for example, an optical disk, a magnetic disk, a magneto-optical disc, semiconductor memory, or a floppy disk, or via a network.

### Working Example

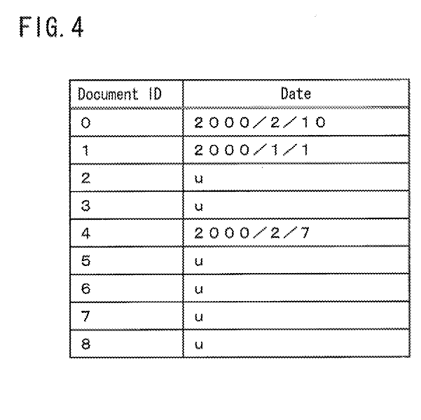

Next is a description of a working example of the information estimation apparatus, the information estimation method, and the program of the present invention, with reference to FIGS. 4 to 9. The description below will be given following the steps shown in FIG. 3, with reference to FIGS. 1 to 3 as appropriate.

The working example that will be described below corresponds to the information estimation apparatus, the information estimation method, and the program according to the embodiment described above. In the present working example, a keyboard and a mouse are used as the input apparatus 20. Further, the information estimation apparatus 1 is realized by installing the program in a computer. Moreover, a magnetic-disk recording apparatus provided in the above computer is used as the storage apparatus 10. Further, a display apparatus is used as the output apparatus 30.

Processing for Determining Transmission Point in Time: Step A1

In the present working example, the reference time point determination unit 2 (see FIG. 1) determines, with respect to the content of each document included in a document set stored in the storage apparatus 10, whether a transmission point in time is known or unknown. In the case of “known”, the reference time point determination unit 2 also specifies the transmission point in time thereof. The transmission point in time of the document determined here as being known will be a reference point in time for estimation of a transmission point in time in latter processing.

If a transmission point in time of a certain document has been given in advance, the reference time point determination unit 2 can determine the document as “known”, and can determine a document whose transmission point in time is not given as “unknown”. Further, even if the transmission point in time is not given to documents in advance, the reference time point determination unit 2 can attempt to specify the transmission point in time, and determine a document whose transmission point in time was able to be specified as “known”, and determine a document whose transmission point in time was not able to be specified as “unknown”.

Examples of a method for the reference time point determination unit 2 to specify a transmission point in time include various methods using existing technology. An example of a specific method for specifying a transmission point in time is a method for specification, if a transmission point in time of content is explicitly described in a document, from that described information. Further, an example of another method for specifying a transmission point in time is a method for specification based on information extracted from a date expression, a time expression, or an expression indicating a time similar thereto in a document.

Moreover, if information on a feed such as an RSS feed can be obtained separately with respect to a target document or if RDF (Resource Description Framework) information is described in a document, the reference time point determination unit 2 may specify a transmission point in time based on such information. Feed is a distribution format of a web site or a web page such as an RSS (RDF Site Summary, Rich Site Summary, Really Simple Syndication) feed or an Atom feed.

The reference time point determination unit 2 may specify a transmission point in time of a document based on information at an archive point in time obtained when a web page is archived through collection by a crawler or the like, or response information from a web server hosting a target document.

In the present working example, as shown in FIG. 4, for example, a document set to be analyzed includes documents having document IDs “0” to “8” (Documents (0) to (8)). A document ID is an identifier for distinguishing each document. A document ID may be indicated by a URL or the like. Here, FIG. 4 is a diagram showing results of determination as to whether the transmission point in time of each document indicated by a document ID is specified. In FIG. 4, if a transmission point in time is known, that date is shown, and if a transmission point in time is unknown, information indicating “unknown” is shown.

Specifically, in FIG. 4, the transmission date of content of Document (0) is specified as “Feb. 10, 2000”, which indicates “known”. Further, in FIG. 4, it is determined that the transmission date of content of Document (2) is unknown, and “u” that is a flag indicating “unknown” has been input.

Link Relationship Extraction Processing: Step A2

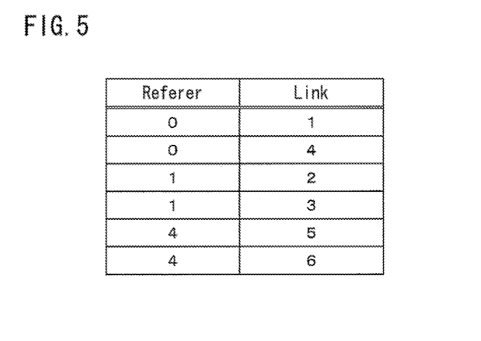

The structure analysis unit 3 specifies a document that has a document structure in which a link relationship with another document is indicated in a table-of-contents manner from a document set to be analyzed, and extracts the link relationship. A specific example is shown in FIG. 5. FIG. 5 is a diagram showing referers and links in the link relationship shown in FIG. 2. As shown in FIG. 5, the link relationship (see FIG. 2) is extracted from the document structure in which the link relationship with another document in the document set is indicated in a table-of-contents manner. A link relationship is specified by the correspondence between the document ID of a referer and the document ID of a link.

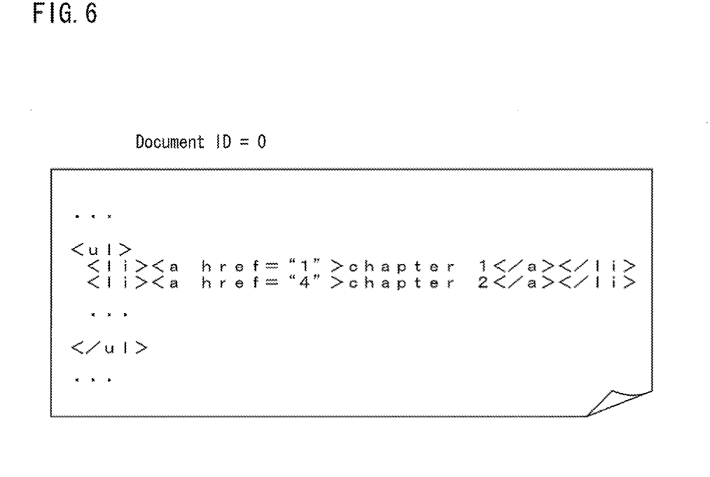

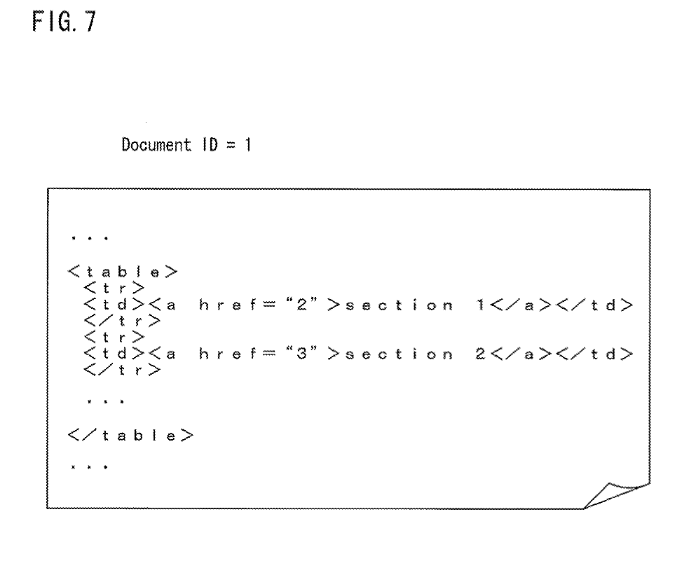

Here, examples of a document structure in which a link relationship of a document with another document is indicated in a table-of-contents manner are shown using FIGS. 6 and 7. FIGS. 6 and 7 are diagrams showing examples of a document structure in which a link relationship of an arbitrary document with another document is indicated in a table-of-contents manner. Note that in FIGS. 6 and 7, a document to be analyzed is a web page, and an HTML document. Further, FIG. 6 shows a part of the HTML of Document (0), and FIG. 7 shows a part of the HTML of Document (1).

As shown in FIG. 6, in the present working example, Document (0) has a description that indicates an itemized configuration using UL elements. Then, LI elements include hyperlinks to Documents (1) and (4), and include character strings such as “chapter 1” and “chapter 2” that indicate a part of a table of contents of a document as anchor texts.

As shown in FIG. 7, Document (1) has a description that indicates a table configuration using TABLE elements. TD elements include hyperlinks to Documents (2) and (3), and include character strings such as “section 1” and “section 2” that indicate a part of the table of contents of a document as anchor texts.

Note that there are various document structures in which a link relationship with another document is indicated in a table-of-contents manner shown in FIGS. 6 and 7, other than the above structures. The present invention is not limited to the examples shown in FIGS. 6 and 7.

In the present working example, an example of a method for specifying a document structure in which a link relationship with another document is indicated in a table-of-contents manner is a method for specifying a document structure by determining a pattern serving as a feature of the document structure. Further, in this method, determination can be performed by combining a plurality of patterns as described above, and in this case, it is sufficient to combine patterns and make a rule. As such a rule, if a document is HTML or XML data, a condition that such data has an anchor element enclosed by specific tags, a condition that such data has a partial structure indicated by a specific Xpath, or the like is applicable, for example.

For example, if an Xpath is used, a specific document structure can be designated using a syntax such as “//ul/li/a”, “//li[@class=“chapter”]/a”, or “/html/body/table/tbody/tr/td/a”. Similarly, if a link relationship is used, a specific document structure can be designated using “//ul/li/a/@href” or “//li/[@class=“chapter”]/a/@href”, which is an Xpath.

Further, in order to increase the accuracy of determination, a condition that an anchor text, an attribute name, or a peripheral text node included in a specific document structure has a specific word or character string, or the like may be added. This is because, for example, if character strings of anchor texts or title attributes include a character string such as “previous”, “next”, “last month”, “next month”, “last issue”, “next issue”, “>>”, “NEXT”, or “read more”, there is a high possibility that such a character string is a constituent element of a logical document composition.

Moreover, an example of another method for specifying a document structure in which a link relationship with another document is indicated in a table-of-contents manner is a method in which a score or a probability value is combined with a specific rule, taking into consideration the likelihood of a document becoming an element of a group having the same transmission point in time. For example, a large number of patterns that can serve as a feature of a document structure in which a link relationship with another document is indicated in a table-of-contents manner are listed as candidates, and a score is given to each pattern. Then, if an adoption condition such as a score threshold value determined in advance is satisfied, using a sum or product of scores, it may be determined that the link relationship indicates candidates for a group having the same transmission point in time. For example, in the case of an HTML document, such patterns serving as a feature can be created exhaustively based on arbitrary subtrees of a DOM tree, or text and element information included in these subtrees.

Other than these, an example of another method for specifying a document structure in which a link relationship with another document is indicated in a table-of-contents manner is a method in which a training document set where a group having the same transmission point in time is specified in advance is prepared. In this method, using a link relationship between documents in a group, a pattern serving as a feature of a document structure related to the link, and a known machine learning technique, it is determined from a training document set, whether a document structure is such a document structure.

For example, in the training document set in which a group having the same transmission point in time is specified in advance, an event in which a certain document structure is true is assumed to be Event C, and the probability of occurrence of Event C at that time is assumed to be P(C). Further, in the training document set, the conditional probability that a document structure feature pattern Xᵢ exists under the condition where Event C occurs is assumed to be P(Xᵢ|C). In such a case, according to the naive Bayes probability model, the likelihood of a document becoming an element of a group having the same transmission point in time can be modeled as shown by Equation 1 below. Here, α is a constant depending on the probability P(Xᵢ) in which each event Xᵢ occurs.

$$P ( C \vert {X}_{1} , … , {X}_{n} ) = α P ( C ) {\prod }_{i = 1}^{n} P ( {X}_{i} \vert C ) \qquad [ Equation 1 ]$$

The model represented by Equation 1 above is applied to a target document, and if it is determined that the document has a certain probability value or more based on the obtained probability value, it is sufficient for the link relationship of the portion corresponding to the document structure to be extracted as a candidate for a group having the same transmission point in time.

In the same way as Event C in the model, Event C2 in which a certain document structure is false in a training document set can also be modeled. In this case, P(C2|X₁, . . . , Xₙ) can be obtained. Then, by using a known maximum a posteriori estimation method (MAP estimation method) with respect to P(C2|X₁, . . . , Xₙ) and the probability obtained using Equation 1 above, it is possible to determine whether the document structure indicates a candidate for a group having the same transmission point in time. Specifically, if it is determined that the document structure is likely to indicate a candidate for a group having the same transmission point in time, it is sufficient for the link relationship of the portion corresponding to the document structure to be extracted as a candidate for the group having the same transmission point in time.

Group Setting Processing: Step A3

In the present working example, the grouping unit 4 sets a group of documents, using a document having content whose transmission point in time is specified by the reference time point determination unit 2, in addition to a document specified by the structure analysis unit 3 and the link relationship likewise extracted thereby. Further, at this time, the grouping unit 4 sets a group of documents whose transmission point in time is estimated to be the same, such that the transmission points in time of content do not overlap.

In the setting of a group of documents whose transmission point in time is estimated to be the same, a document that has a document structure in which the link relationship with another document is indicated in a table-of-contents manner specified by the structure analysis unit 3 is assumed to be an initial element. Then, a document that is a candidate for a group whose transmission point in time is estimated to be the same and is in the link relationship with the above document is extracted, and is added to the group, thereby setting a group.

At this time, if a new document to be added to the group is a document whose transmission point in time is specified, this document will not be added. On the other hand, at this time, in the case where a document to be added is a document whose transmission point in time is unknown, if it can be seen that this document redundantly belongs to another group, that document will be preferentially added to a group having an earlier transmission point in time.

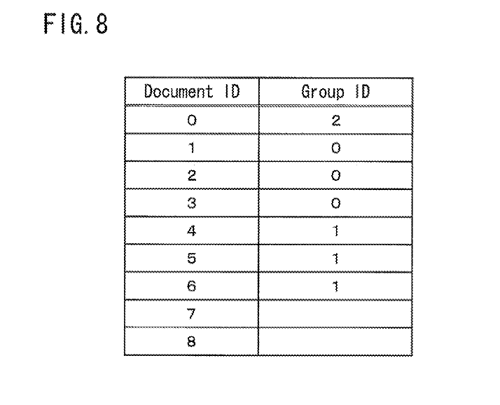

Here, an example of group setting performed by the grouping unit 4 will be described. For example, if information in FIGS. 4 and 5 is used, groups shown in FIG. 8 are set. FIG. 8 is a diagram showing an example of group setting. In FIG. 8, a group having the same transmission point in time is identified based on a specific group ID. In the example in FIG. 8, Documents (1), (2), and (3) have the same group ID “0”, and belong to the same group. The same applies to the group IDs “1” and “2”.

Below is a specific description of a group setting procedure shown in FIG. 8. First, a candidate group constituted by a document having a document ID of a referer and a set of a document serving as a link having the document ID of the referer is created, with reference to FIG. 5. Next, a referral document of documents that constitute each candidate group is checked, and the following processing is executed on referral documents whose transmission point in time is determined as being known in chronological order of the transmission points in time.

For example, among the documents that serve as the referer shown in FIG. 5, a document whose transmission point in time is the earliest shown in FIG. 4 is Document (1). Accordingly, a candidate group including Document (1) is generated. Further, a candidate group having Document (2) whose transmission point in time is the second earliest as the referer is generated similarly. Note that Document (0) serves as a referral document, and has Documents (1) and (4) as links. However, since the transmission points in time of Documents (1) and (4) are already known, these documents will not be added to the group including Document (0).

In another example of a group setting procedure shown in FIG. 8, the referral documents shown in FIG. 5 are referenced in the order of document ID, a document ID of a link that is a candidate for a group having the same transmission point in time is specified, and a group is generated using the specified linked document as a reference. If this procedure is adopted, when there is a document that can also be added to a group having another transmission point in time and causes redundancy in the group generation, such a document that causes redundancy is preferentially included in a document group having an earlier transmission point in time.

For example, a group having Documents (1) and (4) as group elements is set first using Document (0) as a reference, as shown in FIG. 5. However, Documents (1) and (4) have earlier transmission points in time than that of Document (0), and each will also belong to a group other than the group including Document (0). Therefore, Documents (1) and (4) will not be added to the group including Document (0).

Estimation Processing: Step A4

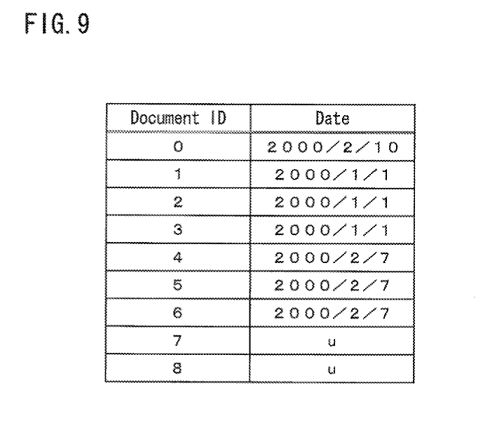

The estimation unit 5 estimates a transmission point in time of a document whose transmission point in time is unknown, based on the group set by the grouping unit 4 and a document whose transmission point in time is known. In the present working example, with respect to a group generated by the grouping unit 4, using a document whose transmission point in time is known in that group, the estimation unit 5 gives the known transmission point in time of the document to the document whose transmission point in time is unknown. In this case, FIG. 4 is updated as shown in FIG. 9 based on the documents whose transmission point in time is known in FIG. 4 and groups shown in FIG. 8. FIG. 9 is a diagram showing the results of estimation processing.

The transmission point in time of a document that is not included in a group can be estimated as follows. First, the estimation unit 5 selects a group in chronological order of documents in the groups, starting from a group that has a document whose transmission point in time is the earliest, and for each document included in the selected group, takes the document as a starting point, and follows a linked document of a link relationship that starts from each document taken as a starting point (a link relationship with a document outside the group). Moreover, based on the link relationship from the document, the estimation unit 5 repeatedly follows a linked document in order, and specifies linked documents. Then, the estimation unit 5 determines whether the transmission point in time of the specified documents is known or unknown, and here, if the estimation unit 5 encounters a document whose transmission point in time is known while following documents, the estimation unit 5 does not follow the link relationship any further. Further, if the estimation unit 5 reaches a document whose transmission point in time is unknown as a result of following links, the estimation unit 5 applies the transmission point in time of a document in the selected group (the document taken as a starting point) to the document that is reached, and estimates that this is the transmission point in time of the document. The reason for performing estimation by following links in a group in chronological order of documents in the groups, starting from a group having the earliest document is because a document that has been present from an earlier time is often referenced later as in the reference relationship of hyperlinks, or the like. Thus, a transmission point in time can be estimated with higher accuracy if estimation is performed on documents whose transmission point in time.is unknown, in chronological order.

For example, a specific example will be described below. First, if groups are selected in chronological order of the transmission point in time from the groups including documents whose transmission point in time is determined in FIG. 9, groups can be selected in the order of group IDs “0”, “1”, and “2”. Next, with regard to the groups selected in chronological order of the transmission point in time, it can be seen that, for example, the group having the group ID “0” has Documents (2) and (3) as documents whose transmission point in time is unknown.

Next, a link is followed based on the link relationship, using each document ID as a referer. As a result, it is not possible to reach, from Document (2), a new document that is not included in a group and whose transmission point in time is unknown. On the other hand, Document (7) can be reached as a new link from Document (3). Accordingly, the transmission point in time of Document (3) can be applied to Document (7).

Similarly, with regard to Document (5) having the group ID “1”, Document (8) can be newly followed as a link, and the transmission point in time of Document (5) can be applied to Document (8).

The estimation unit 5 can exclude a link relationship that can be determined as being unnecessary. For example, an unnecessary link is a link relationship that does not constitute a group whose transmission point in time is estimated to be the same or a link relationship for which giving a transmission date is meaningless. Examples of such a link relationship include a link relationship with a top page included in any page irrespective of the transmission point in time, a mechanically generated link relationship, and the like.

For example, there are cases such as where a character string such as “advertisement”, “TOP”, or “inquiry” is included in an anchor text, where a URL mechanically generated and including a parameter that indicates a command to an application is described, where it can be seen that a URL belongs to another unrelated domain, and the like. It is possible to consider that such link relationships do not need to be reflected in the specification of the transmission point in time. It is preferable to exclude such link relationships when necessary.

As described above, according to the present working example, even in the case where either a transmission date or a time expression is not explicitly described in a document that constitutes content, it is possible to estimate the transmission point in time of that content.

Hereinabove, the invention was described with reference to an embodiment and a working example, but the invention is not limited to the above embodiment or working example. The configurations and details of the invention can be modified within the scope of the invention that a person skilled in the art would understand.

This application claims priority to Japanese Patent Application No. 2008-335328 filed on Dec. 26, 2008, the disclosure of which is incorporated in its entirety herein by reference.

The information estimation apparatus, the information estimation method, and the computer-readable recording medium of the present invention have the following features.

(1) An information estimation apparatus for estimating a transmission point in time of a document whose transmission point in time is not specified in a document set to be analyzed, including:

a structure analysis unit configured to specify, from the document set, a document having a document structure in which a link relationship with another document is indicated in a table-of-contents manner, and extract the link relationship of documents included in the document set from the document structure of the specified document;

a grouping unit configured to set a group of documents using the document specified by the structure analysis unit and the link relationship extracted by the structure analysis unit; and

an estimation unit configured to estimate, based on the group set by the grouping unit and a transmission point in time of a document that is included in the group and whose transmission point in time is specified, a transmission point in time of a document that is included in the group and whose transmission point in time is not specified.

(2) The information estimation apparatus according to the above (1),

wherein the grouping unit sets the group by combining the document whose transmission point in time is specified and a document whose transmission point in time is not specified and that has a link relationship with the document whose transmission point in time is specified, the link relationship having been extracted by the structure analysis unit.

(3) The information estimation apparatus according to the above (1),

wherein in a case where the document whose transmission point in time is not specified has a link to a plurality of documents whose transmission point in time is specified, the grouping unit sets the group by combining the document whose transmission point in time is not specified with a document whose specified transmission point in time is earlier.

(4) The information estimation apparatus according to the above (1),

wherein the estimation unit estimates that the transmission point in time of the document whose transmission point in time is not specified in the group is the transmission point in time of the document whose transmission point in time is specified in the group.

(5) The information estimation apparatus according to the above (1),

wherein the grouping unit sets a plurality of groups, and

the estimation unit selects a group, from among the plurality of groups, in chronological order of documents in the groups, starting from a group having a document whose transmission point in time is the earliest, and for each document included in the selected group, takes the document as a starting point and specifies a document that is reachable by following linked documents in order from the starting point, and if a transmission point in time of the specified document is not specified, estimates that the transmission point in time of the specified document is a transmission point in time of the document taken as the starting point.

(6) The information estimation apparatus according to the above (1), further including:

a reference time point determination unit configured to determine, with respect to each document included in the document set to be analyzed, whether a transmission point in time is specified.

(7) The information estimation apparatus according to the above (1),

wherein a document included in the document set is a web page, and

the structure analysis unit specifies a document having the document structure in which a link relationship with another document is indicated in a table-of-contents manner, using a hyperlink and at least one of an HTML tag and a subtree of a DOM tree that are described in the web page.

(8) An information estimation method for estimating a transmission point in time of a document whose transmission point in time is not specified in a document set to be analyzed, including the steps of:

(a) specifying, from the document set, a document having a document structure in which a link relationship with another document is indicated in a table-of-contents manner, and extracting the link relationship of documents included in the document set from the document structure of the specified document;

(b) setting a group of documents using the document specified in the step (a) and the link relationship extracted in the step (a); and

(c) estimating, based on the group set in the step (b) and a transmission point in time of a document that is included in the group and whose transmission point in time is specified, a transmission point in time of a document that is included in the group and whose transmission point in time is not specified.

(9) The information estimation method according to the above (8),

wherein the step (b) includes setting the group by combining the document whose transmission point in time is specified and a document whose transmission point in time is not specified and that has a link relationship with the document whose transmission point in time is specified, the link relationship having been extracted in the step (a).

(10) The information estimation method according to the above (8),

wherein in a case where the document whose transmission point in time is not specified has a link to a plurality of documents whose transmission point in time is specified, the step (b) includes setting the group by combining the document whose transmission point in time is not specified with a document whose specified transmission point in time is earlier.

(11) The information estimation method according to the above (8),

wherein the step (c) includes estimating that the transmission point in time of the document whose transmission point in time is not specified in the group is the transmission point in time of the document whose transmission point in time is specified in the group.

(12) The information estimation method according to the above (8),

wherein the step (b) includes setting a plurality of groups, and

the step (c) includes selecting a group, from among the plurality of groups, in chronological order of documents in the groups, starting from a group having a document whose transmission point in time is the earliest, and for each document included in the selected group, taking the document as a starting point and specifying a document that is reachable by following linked documents in order from the starting point, and if a transmission point in time of the specified document is not specified, estimating that the transmission point in time of the specified document is a transmission point in time of the document taken as the starting point.

(13) The information estimation method according to the above (8), further including the step of:

(d) determining, with respect to each document included in the document set to be analyzed, whether a transmission point in time is specified.

(14) The information estimation method according to the above (8),

wherein a document included in the document set is a web page, and

the step (a) includes specifying a document having the document structure in which a link relationship with another document is indicated in a table-of-contents manner, using a hyperlink and at least one of an HTML tag and a subtree of a DOM tree that are described in the web page.

(15) A computer-readable recording medium having recorded thereon a program for causing a computer to estimate a transmission point in time of a document whose transmission point in time is not specified in a document set to be analyzed, the program including a command for causing the computer to execute the steps of:

(a) specifying, from the document set, a document having a document structure in which a link relationship with another document is indicated in a table-of-contents manner, and extracting the link relationship of documents included in the document set from the document structure of the specified document;

(b) setting a group of documents using the document specified in the step (a) and the link relationship extracted in the step (a); and

(c) estimating, based on the group set in the step (b) and a transmission point in time of a document that is included in the group and whose transmission point in time is specified, a transmission point in time of a document that is included in the group and whose transmission point in time is not specified.

(16) The computer-readable recording medium according to the above (15),

wherein the step (b) includes setting the group by combining the document whose transmission point in time is specified and a document whose transmission point in time is not specified and that has a link relationship with the document whose transmission point in time is specified, the link relationship having been extracted in the step (a).

(17) The computer-readable recording medium according to the above (15),

wherein in a case where the document whose transmission point in time is not specified has a link to a plurality of documents whose transmission point in time is specified, the step (b) includes setting the group by combining the document whose transmission point in time is not specified with a document whose specified transmission point in time is earlier.

(18) The computer-readable recording medium according to the above (15),

wherein the step (c) includes estimating that the transmission point in time of the document whose transmission point in time is not specified in the group is the transmission point in time of the document whose transmission point in time is specified in the group.

(19) The computer-readable recording medium according to the above (15),

wherein the step (b) includes setting a plurality of groups, and

the step (c) includes selecting a group, from among the plurality of groups, in chronological order of documents in the groups, starting from a group having a document whose transmission point in time is the earliest, and for each document included in the selected group, taking the document as a starting point and specifying a document that is reachable by following linked documents in order from the starting point, and if a transmission point in time of the specified document is not specified, estimating that the transmission point in time of the specified document is a transmission point in time of the document taken as the starting point.

(20) The computer-readable recording medium according to the above (15), further causing the computer to execute the step of:

(d) determining, with respect to each document included in the document set to be analyzed, whether a transmission point in time is specified.

(21) The computer-readable recording medium according to the above (15),

wherein a document included in the document set is a web page, and

the step (a) includes specifying a document having the document structure in which a link relationship with another document is indicated in a table-of-contents manner, using a hyperlink and at least one of an HTML tag and a subtree of a DOM tree that are described in the web page.

### INDUSTRIAL APPLICABILITY

The present invention is effective in the case of creating time series data for web pages. Further, the present invention is also applicable to the case of performing analysis using time series data of documents or web pages, the case of creating an index with time information of documents, and the case of searching information in time series based on a search condition. The present invention has industrial applicability.

### DESCRIPTION OF REFERENCE NUMERALS

1 Information estimation apparatus
2 Reference time point determination unit
3 Structure analysis unit
4 Grouping unit
5 Estimation unit
6 Input receiving unit
10 Storage apparatus
11 Document storage unit
20 Input apparatus
30 Output apparatus

1. An information estimation apparatus for estimating a transmission point in time of a document whose transmission point in time is not specified in a document set to be analyzed, comprising:
a structure analysis unit configured to specify, from the document set, a document having a document structure in which a link relationship with another document is indicated in a table-of-contents manner, and extract the link relationship of documents included in the document set from the document structure of the specified document;
a grouping unit configured to set a group of documents using the document specified by the structure analysis unit and the link relationship extracted by the structure analysis unit; and
an estimation unit configured to estimate, based on the group set by the grouping unit and a transmission point in time of a document that is included in the group and whose transmission point in time is specified, a transmission point in time of a document that is included in the group and whose transmission point in time is not specified.

2. The information estimation apparatus according to claim 1,
wherein the grouping unit sets the group by combining the document whose transmission point in time is specified and a document whose transmission point in time is not specified and that has a link relationship with the document whose transmission point in time is specified, the link relationship having been extracted by the structure analysis unit.

3. The information estimation apparatus according to claim 1,
wherein in a case where the document whose transmission point in time is not specified has a link to a plurality of documents whose transmission point in time is specified, the grouping unit sets the group by combining the document whose transmission point in time is not specified with a document whose specified transmission point in time is earlier.

4. The information estimation apparatus according to claim 1,
wherein the estimation unit estimates that the transmission point in time of the document whose transmission point in time is not specified in the group is the transmission point in time of the document whose transmission point in time is specified in the group.

5. The information estimation apparatus according to claim 1,
wherein the grouping unit sets a plurality of groups, and
the estimation unit selects a group, from among the plurality of groups, in chronological order of documents in the groups, starting from a group having a document whose transmission point in time is the earliest, and for each document included in the selected group, takes the document as a starting point and specifies a document that is reachable by following linked documents in order from the starting point, and if a transmission point in time of the specified document is not specified, estimates that the transmission point in time of the specified document is a transmission point in time of the document taken as the starting point.

6. The information estimation apparatus according to claim 1, further comprising:
a reference time point determination unit configured to determine, with respect to each document included in the document set to be analyzed, whether a transmission point in time is specified.

7. The information estimation apparatus according to claim 1,
wherein a document included in the document set is a web page, and
the structure analysis unit specifies a document having the document structure in which a link relationship with another document is indicated in a table-of-contents manner, using a hyperlink and at least one of an HTML tag and a subtree of a DOM tree that are described in the web page.

8. An information estimation method for estimating a transmission point in time of a document whose transmission point in time is not specified in a document set to be analyzed, comprising the steps of:
(a) specifying, from the document set, a document having a document structure in which a link relationship with another document is indicated in a table-of-contents manner, and extracting the link relationship of documents included in the document set from the document structure of the specified document;
(b) setting a group of documents using the document specified in the step (a) and the link relationship extracted in the step (a); and
(c) estimating, based on the group set in the step (b) and a transmission point in time of a document that is included in the group and whose transmission point in time is specified, a transmission point in time of a document that is included in the group and whose transmission point in time is not specified.

9. The information estimation method according to claim 8,
wherein the step (b) comprises setting the group by combining the document whose transmission point in time is specified and a document whose transmission point in time is not specified and that has a link relationship with the document whose transmission point in time is specified, the link relationship having been extracted in the step (a).

10. The information estimation method according to claim 8,
wherein in a case where the document whose transmission point in time is not specified has a link to a plurality of documents whose transmission point in time is specified, the step (b) comprises setting the group by combining the document whose transmission point in time is not specified with a document whose specified transmission point in time is earlier.

11. The information estimation method according to claim 8,
wherein the step (c) comprises estimating that the transmission point in time of the document whose transmission point in time is not specified in the group is the transmission point in time of the document whose transmission point in time is specified in the group.

12. The information estimation method according to claim 8,
wherein the step (b) comprises setting a plurality of groups, and
the step (c) comprises selecting a group, from among the plurality of groups, in chronological order of documents in the groups, starting from a group having a document whose transmission point in time is the earliest, and for each document included in the selected group, taking the document as a starting point and specifying a document that is reachable by following linked documents in order from the starting point, and if a transmission point in time of the specified document is not specified, estimating that the transmission point in time of the specified document is a transmission point in time of the document taken as the starting point.

13. The information estimation method according to claim 8, further comprising the step of:
(d) determining, with respect to each document included in the document set to be analyzed, whether a transmission point in time is specified.

14. The information estimation method according to claims 8,
wherein a document included in the document set is a web page, and
the step (a) comprises specifying a document having the document structure in which a link relationship with another document is indicated in a table-of-contents manner, using a hyperlink and at least one of an HTML tag and a subtree of a DOM tree that are described in the web page.

15. A computer-readable recording medium having recorded thereon a program for causing a computer to estimate a transmission point in time of a document whose transmission point in time is not specified in a document set to be analyzed, the program including a command for causing the computer to execute the steps of:
(a) specifying, from the document set, a document having a document structure in which a link relationship with another document is indicated in a table-of-contents manner, and extracting the link relationship of documents included in the document set from the document structure of the specified document;
(b) setting a group of documents using the document specified in the step (a) and the link relationship extracted in the step (a); and
(c) estimating, based on the group set in the step (b) and a transmission point in time of a document that is included in the group and whose transmission point in time is specified, a transmission point in time of a document that is included in the group and whose transmission point in time is not specified.

16. The computer-readable recording medium according to claim 15,
wherein the step (b) comprises setting the group by combining the document whose transmission point in time is specified and a document whose transmission point in time is not specified and that has a link relationship with the document whose transmission point in time is specified, the link relationship having been extracted in the step (a).

17. The computer-readable recording medium according to claim 15,
wherein in a case where the document whose transmission point in time is not specified has a link to a plurality of documents whose transmission point in time is specified, the step (b) comprises setting the group by combining the document whose transmission point in time is not specified with a document whose specified transmission point in time is earlier.

18. The computer-readable recording medium according to claim 15,
wherein the step (c) comprises estimating that the transmission point in time of the document whose transmission point in time is not specified in the group is the transmission point in time of the document whose transmission point in time is specified in the group.

19. The computer-readable recording medium according to claim 15,
wherein the step (b) comprises setting a plurality of groups, and
the step (c) comprises selecting a group, from among the plurality of groups, in chronological order of documents in the groups, starting from a group having a document whose transmission point in time is the earliest, and for each document included in the selected group, taking the document as a starting point and specifying a document that is reachable by following linked documents in order from the starting point, and if a transmission point in time of the specified document is not specified, estimating that the transmission point in time of the specified document is a transmission point in time of the document taken as the starting point.

20. The computer-readable recording medium according to claim 15, further causing the computer to execute the step of:
(d) determining, with respect to each document included in the document set to be analyzed, whether a transmission point in time is specified.

21. The computer-readable recording medium according to claim 15,
wherein a document included in the document set is a web page, and
the step (a) comprises specifying a document having the document structure in which a link relationship with another document is indicated in a table-of-contents manner, using a hyperlink and at least one of an HTML tag and a subtree of a DOM tree that are described in the web page.
